(19) United States
(12) Patent Application Publication
(10) Pub. No.: US 2004/0047955 A1
(43) Pub. Date: Mar. 11, 2004

(54) Color-enhanced food product

(76) Inventors: Thomas A. Arrendale III, Baldwin, GA (US); Chester L. Crum JR., St. Petersburg, FL (US)

Correspondence Address: JINAN GLASGOW, P O BOX 28539, RALEIGH, NC, 276118539

(21) Appl. No.: 10/406,657

(22) Filed: Apr. 3, 2003

Related U.S. Application Data
(63) Continuation-in-part of application No. 10/236,215, filed on Sep. 6, 2002.
(63) Continuation-in-part of application No. 10/237,644, filed on Sep. 9, 2002.

(51) Int. Cl. A23L 1/27; A23B 4/00

(52) U.S. Cl. 426/262

(57) ABSTRACT

A breading for foods that has color-enhanced, visual and textural characteristics that make a food attractive and/or appealing, in particular to children. Also, a color-enhanced composite food product, including a color-enhanced breading and at least one meat component wherein the meat component and color-enhanced breading are combined without substantial intermixing.

### CROSS-REFERENCE TO RELATED APPLICATIONS

This non-provisional utility patent application claims the benefit of one or more prior filed copending nonprovisional applications; the present application is a Continuation-In-Part of application Ser. No. 10/236215 and 10/237644, which are incorporated of application Ser. No. 10/236,215 and 10/237,644, which are incorporated

### BACKGROUND OF THE INVENTION

(1) Field of the Invention

The present invention relates generally to food products and, more particularly, to a color-enhanced, particulate breading for composite food products, specifically meat products.

(2) Description of the Prior Art

Protein is an important component of a human's diet and animal protein is especially important for young children because it is a good source of B vitamins. Replacement of animal protein with vegetable sources of protein is difficult due to the difficulty in matching the amino acid and B-vitamin needs of a growing child with vegetarian sources. Thus, ensuring that a child receives a proper amount of animal protein is important for the proper development of the child. Some children, however, are not attracted to animal protein and refuse to eat it in adequate amounts. Therefore, a need exists for an animal protein product that is attractive to children and highly nutritious.

### SUMMARY OF THE INVENTION

The present invention is directed to a color-enhanced, particulate breading for composite food products, specifically meat products. In a preferred embodiment, the present invention provides a color-enhanced, particulate breading foodstuff that is preferably used in combination with at least one meat component, without substantial intermixing of the breading and the meat component, i.e., the two components are stratified. Thus it is one aspect of the present invention to provide a breading for foods that has color-enhanced, visual and textural characteristics that make a food attractive and/or appealing, in particular to children. It is another aspect of the present invention to provide a color-enhanced composite food product, including a color-enhanced breading and at least one meat component wherein the meat component and color-enhanced breading are combined without substantial intermixing.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

As used within this application, the term “stratified” is used to indicate a separate and distinct component that exists separately without intermixing with another component, which may be layered, e.g., a coating layer is applied onto a carrier layer or component, and the like, which remains separate and distinct without mixing with each other. Also, as used within this application, the term “composite” is used to indicate a structure or product made up of distinct components to form a complex product in which two or more distinct, complementary food substances or components, specifically a meat component and a foodstuff component with at least one nutritional enhancer or additive, are combined without mixing to produce properties in the overall combined product that are not present in either of the two separate components independently.

In the case of an embodiment having a composite food product, the product includes a first core, substrate, or carrier meat, with which a second color-enhanced foodstuff is combined, which is preferably a breading, including at least one color enhancer, wherein the foodstuff is stratified from first carrier meat, i.e., the foodstuff and its at least one nutritional enhancer is combined with but exists separately therefrom without mixing therewith.

Furthermore, the present invention provides a breading for foods that has color-enhanced, visual and textural characteristics that make a food attractive and/or appealing, in particular to children. The breading includes at least one color enhancer, which includes at least one colorant, which may include natural and/or artificial colorants. The colorant(s) are preferably selected from colors that children find attractive. In general, these include at least the primary or rainbow colors—red, orange, yellow, green, blue, indigo, and violet, which are preferably included either individually or alternatively or in combination, in various embodiments consistent with the present invention, e.g., in a package containing a multiplicity of pieces of a composite food product, each piece may have the same or similar color, each piece may have a multiplicity of distinct colors, like a variegation, spotting, or striping, or pieces may have solid colors but a variety of colors may be included in one package having multiple pieces, according to various embodiments according to the present invention.

Although primarily utilized to make the composite food product more attractive, the colorant may also function as a physiological antioxidant, thus providing another essential nutrient to the child. For example, colored antioxidants such as some flavonoids, carotenoids, anthocyanins and the like, from tomatoes, black currants, grapes, blueberries, cranberries and the like may be used to impart a color to the particulate. These can be used as the natural product, or as the refined or partially-refined product. For example, refined catechins, resveratrol, anthocyanin, beta-carotenes, lycopene, lutein, zeaxanthin and the like may be used as the colorant. Of course, non-colored antioxidants can also be added to provide more nutrition to the consumer.

Also, the breading may be optionally nutritionally enhanced for providing supplemental nutritional qualities to the composite food product, in particular additionalitional protein and/or nutrients, including vitamins and minerals, such as calcium, iron, riboflavin, niacin, folate, thiamin, and the like, essential fatty acids, such as omega-3 and omega-6 fatty acids, amino acids, such as arginine; proteins, such as digestive enzymes, e.g., papain; and carbohydrates, such as glucosamine and chondroitin, and the like. Additionally or alternatively, the breading may be flavor enhanced.

The present invention also further provides a composite food product including the color-enhanced breading and a meat component that are combined without intermixing. In one embodiment, the breading includes whole cereal(s) that are selected and/or processed to provide a crispy texture in order to provide a predetermined quality of texture, e.g., crunch, crisp, soft, flaky, etc. Preferably, the cereal includes rice. Also preferably, the rice has a crisp and/or crunchy texture. Because people, in particular children, are attracted to brightly-colored objects and noisy objects, food products with these characteristics will tend to be attractive to them, thus encouraging them to eat the food product.

The breading according to the present invention preferably includes a particulate component that is color-enhanced, i.e., colored particles. The size of the particulate can range from between about 0.1 to about 0.5 cm.

The particulate may optionally also make noise when masticated or chewed by a person such that a person who enjoys crunching the breading between his teeth will be attracted to a product containing the breading. Thus, the particulate may be of a sufficient texture such that a noise is made when the particulate is chewed.

Preferably, the particulate is formed by flash cooking, that is, puffing or popping, a particulate. Puffed and popped rices are traditional breakfast cereals and snack foods (Juliano and Sakurai, 1985). Raw rice is traditionally popped by heating rough rice (13 to 17 percent moisture) at about 240° C. for 30 to 35 seconds or at 275° C. for 40 to 45 seconds or in an oil bath at 215 to 230° C. The hull contributes to pressure retention before popping as evidenced by the lower popping percentage of brown rice. Good popping varieties have a tight hull and a significant clearance between hull and brown rice and when freshly harvested are free of grain fissures (Srinivas and Desikachar, 1973). Tightness of hull, grain hardness and degree of translucency could explain 80 percent of the variation in popping expansion among 25 rice varieties (Murugesan and Bhattacharya, 1991). Flaked or beaten brown rice and parboiled milled rice may be converted to puffed rice by heating in hot air or roasting in hot sand (Juliano and Sakurai, 1985; Villareal and Juliano, 1987). With normal parboiled milled rice, puffed volume is directly proportional to the severity of parboiling (equilibrium water content of steeped grain prior to parboiling) and is highest for waxy rice (Antonio and Juliano, 1973). Puffed waxy and low-amylose rices tend to have a higher puffed volume than intermediate- to high-amylose rices only when grains are incompletely parboiled or cooked before oil puffing (Villareal and Juliano, 1987). However, with increasing temperature and period of roasting of rough rice, high-amylose rice (specifically 27 percent) gives the maximum puffed volume for roasted beaten rice (Chinnaswamy and Bhattacharya,1984). Puffed non-waxy rice and flattened waxy rice are caramelized and moulded and are common snack foods in the Philippines. A typical Japanese rice cake, okoshi, is made of puffed broken rice mixed and moulded with millet jelly, sugar and flavouring. Gun-puffing of moist milled rice may be considered as puffing rather than popping since the grains are gelatinized prior to expansion. The expansion ratio was higher for waxy milled rice than for non-waxy rice (Villareal and Juliano, 1987). The expansion ratio for gun-puffed milled rice or oil-puffed parboiled or boiled milled rice correlated negatively with protein content, except for those rices parboiled at zero steam pressure before oil-puffing. Continuous explosion-puffing of brown rice, developed in Japan in 1971, uses a long heating pipe wherein grains are dispersed and conveyed by a high-velocity stream of superheated steam (Sagara, 1988). After the rice has been heated and dried within 3 to 10 seconds, it is discharged into the atmosphere through a rotary valve to explosion-puff. A brown rice expansion ratio of 5.4 is obtained at 6 kg/cm2 pressure and an outlet steam temperature of 200° C. The puffed product has a starch digestibility of 94 percent after 15 minutes of boiling. Thiamine is not destroyed at 200° C. or lower but is completely destroyed at an outlet steam temperature of 240° C. (Sagara, 1988).

Whole cereals, such as rice, barley, corn, wheat, millet, rye, sorghum, buckwheat, and the like, can be puffed and then used in the present embodiment as the particulate component. Various sizes of the whole cereal can be used. For example, small-kerneled, multi-colored indian corn or larger-kerneled hybrid corn can be used. Different colored rice may also be used, e.g., black rice. Preferably, puffed rice is used in the present embodiment. A combination of grains may also be used. For example, blue and yellow corn may be combined with black and white rice into a single breading.

Various additives can be added to the breading to improve the physical qualitites and/or enhance the nutritional aspects of the breading and composite food product. Binders, such as starches, gums, and carrageenans can be added to ensure that the particulates adhere to one another and to the meat product and form a solid breading to enhance the flavor and texture of the meat and formed food product. Other ingredients used to form the breading include vegetable proteins, salts, and leavening agents.

As set forth in the foregoing, nutritional enhancers are optionally added to the breading foodstuff to increase the nutritional value of the overall composite food product. Nutritional enhancers, as described in co-pending applications Ser. Nos. 10/236215 and 10/237644, Nutritional enhancers, as described in co-pending applications Ser. Nos. 10/236,215 and 10/237,644, or additives that are preferably used to fortify the second foodstuff include vitamins and minerals, such as calcium, iron, riboflavin, niacin, folate, thiamin, and the like, essential fatty acids, such as omega-3 and omega-6 fatty acids, amino acids, such as arginine; proteins, such as digestive enzymes, e.g., papain; and carbohydrates, such as glucosamine and chondroitin. In general, molecules that are essential nutrients or function as biomediators to influence the health and growth of the human body may be used as nutritional additives. The nutrients may be in their simplest chemical state, or chemically bound with other molecules. For example, essential fatty acids, such as docosahexaenoic acid, eicosapentaenoic acid, alpha- and gamma-linolenic acid, dihomogamma linolenic acid, arachidonic acid and linoleic acid, may be provided as such or as oils such as fish oilly. Generally, the compensators K1, K2 can be chosen to have high constant gains such that the error signal e3, e4 are reduced to zero quickly.

The forward-loop compensators C1, C2 can be chosen to be simple proportional-integrate compensators. In addition, they can be chosen to have a general compensator form with a transfer function of C(s)=(b1*s+b0)/(a1*s+1), where the coefficients a1, and b0, b1 are constant coefficients.

This method of the smooth transition switch is based on measuring or estimating the actual switch output variable c. be added to the breading to make the food product more appealing to consumers, in particular to children, whereas capsaicinoids, such as capsaicin, monosodium glutamate, 5′-ribonucleotides, such as disodium 5′-inosinate, (IMP) and/or disodium 5′-guanylate (GMP), and the like may be added to the breading to make the food product more appealing to consumers, in particular to the elderly. Other flavor enhancers that can be included include 2-Acetylpyrazine, Caffeine, Coumarin, delta-Decalactone, delta-Dodecalactone, delta-Undecalactone, Dihydro-Coumarin, 2,3-Dimethylpyrazine, 2,5-Dimethylpyrazine, 2,6-Dimethylpyrazine, D-Xylose, 2-Ethylpyrazine, Ethyl Vanillin, gamma-Decalactone, gamma-Dodecalactone, gamma-Heptalactone, gamma-Noalactone, gamma-Octalactone, gamma-Undecalactone, HVP, Menthol, 2-Methoxy-3(5 or 6)-Methylpyrazine, 2-Methylpyrazine, Methyl Coumarin, Milk Lactone, Natural Strawberry Furanone, Strawberry Furanone, 2,3,5,6-Tetramethylpyrazine, 2,3,5-Trimethylpyrazine and Vanillin.

The described breading can be used as a component in a composite food product as described in co-pending application Ser. Nos. 10/236215 and 10/237644. The composite food as described in co-pending application Ser. Nos. 10/236,215 and 10/237,644. The composite food product would thus use the colored, particulate breading according to the present invention fortified with one or more nutritional enhancers. The nutritional enhancers, as described previously in this specification and in the cross-referenced co-pending application Ser. Nos. 10/236215 and 10/237644, application, may be used to fortify the second application Ser. Nos. 10/236,215 and 10/237,644, application, may be used to fortify the second folate, thiamin, and the like, essential fatty acids, such as omega-3 and omega-6 fatty acids, amino acids, such as arginine; proteins, such as digestive enzymes, e.g., papain; and carbohydrates, such as glucosamine and chondroitin. In general, molecules that are essential nutrients or function as biomediators to influence the health and growth of the human body may be used as nutritional additives. The nutrients may be in their simplest chemical state, or chemically bound with other molecules. For example, essential fatty acids, such as docosahexaenoic acid, eicosapentaenoic acid, linolenic acid and linoleic acid, may be provided as such or as oils such as fish oil and/or flax seed oil.

Also, as set forth in the foregoing, the composite food product may be formed using single-color particulate for each element or it may be formed using different color particulates. In the latter embodiment, a single food product element would have differently colored particles in the breading.

The particulate breading may also use particulates that make noise when eaten, such that people, especially children, will be attracted to bite the food product. Generally, any noise produced is related to the texture of the breading and is optionally included with the color-enhanced breading for added appeal to the consumer.

Preferably, the composite food product is a composite meat product. More preferably, the composite meat product is a fully-cooked or ready-to-cook composite meat product. Even more preferably, the meat product is a composite chicken product.

Shaped foods are also appealing to people, especially children. Therefore, the present invention can also include shapes that the eater may find intriguing or interesting. For example, the food product may be shaped to resemble an animal, a heavenly object, a toy, a letter of an alphabet, a number, a geometric shape, and the like.

Certain modifications and improvements will occur to those skilled in the art upon a reading of the foregoing description. All modifications and improvements have been deleted herein for the sake of conciseness and readability but are properly within the scope of the following claims.

We claim:

1. A color-enhanced composite food product comprising at least one serving element, further comprising:
a first carrier meat,
a second color-enhanced foodstuff that is stratified from the first carrier meat,
the first carrier meat having at least one predetermined dimension providing a portion size for providing predictable nutrient levels of the composite food product, thereby providing an attractive food product.

2. The food product as in claim 1 wherein the carrier meat is selected from the group consisting of chicken, turkey, beef, lamb, fish, shellfish, and pork.

3. The food product as in claim 1 wherein the carrier meat is fully cooked or ready-to-cook.

4. The food product as in claim 1 wherein the color-enhanced foodstuff is exterior to the meat.

5. The food product as in claim 1 wherein the color-enhanced foodstuff is a coating.

6. The food product as in claim 1 wherein the color-enhanced foodstuff is a breading.

7. The food product as in claim 1 wherein the color-enhanced foodstuff includes at least one color enhancer.

8. The food product as in claim 7 wherein the at least one color enhancer includes at least one artificial colorant.

9. The food product as in claim 7 wherein the at least one color enhancer includes at least one natural colorant.

10. The food product as in claim 1 wherein the color-enhanced foodstuff further includes at least one nutritional enhancer.

11. The food product as in claim 10 wherein the at least one nutritional enhancer is selected from the group consisting of vitamins, minerals, fatty acids, amino acids, carbohydrates, antioxidants, and proteins.

12. The food product as in claim 1, wherein the color-enhanced foodstuff is one color.

13. The food product as in claim 1, wherein the color-enhanced foodstuff is multi-colored.

14. The food product as in claim 1, wherein the at least one serving element includes a multiplicity of distinct pieces that have different colors.

15. The food product as in claim 1, wherein the meat component is a shape selected from the group consisting of animals, heavenly objects, toys, letters of an alphabet, numbers, and geometric shapes.

16. The food product as in claim 1, wherein the color-enhanced foodstuff further includes a flavor enhancer.

17. A color-enhanced breading for making a composite food product, comprising:
colored particles and
a binder, wherein the binder is mixed with the colored particles
thereby providing a breading that is visually attractive.

18. The breading as in claim 17, wherein the colored particles include at least one colorant.

19. The breading as in claim 18, wherein the colorant is one color.

20. The breading as in claim 17, wherein the colored particles have a multiplicity of colors.

21. The breading as in claim 18, wherein the colorant is an antioxidant.

22. The breading as in claim 18, wherein the colorant includes a natural colorant.

23. The breading as in claim 22, wherein the natural colorant is an antioxidant.

22. The breading as in claim 18, wherein the colorant includes an artificial colorant.

23. The breading as in claim 17, wherein the particles have a texture that produces noise when chewed.

24. The breading as in claim 17, wherein the particles are made from grains selected from the group consisting of rice, barley, corn, wheat, millet, rye, sorghum, buckwheat, and combinations thereof.

25. The breading as in claim 17, wherein the breading further including at least one nutritional enhancer.

26. The breading as in claim 25, wherein the at least one nutritional enhancer is selected from the group consisting of vitamins, minerals, fatty acids, amino acids, carbohydrates, antioxidants, and proteins.

27. The breading as in claim 17, wherein the breading further includes at least one flavor enhancer.

28. The breading as in claim 17, wherein the breading further contains at least one flavor enhancer and at least one nutritional enhancer and the colored particles also make a noise when chewed.
